(19) United States
(12) Patent Application Publication
(10) Pub. No.: US 2024/0425062 A1
(43) Pub. Date: Dec. 26, 2024

(54) APPARATUS FOR CONTROLLING VEHICLE AND METHOD THEREOF

(71) Applicants: HYUNDAI MOTOR COMPANY, Seoul (KR); Kia Corporation, Seoul (KR)

(72) Inventor: Kyung Joo BANG, Hwaseong-si (KR)

(73) Assignees: HYUNDAI MOTOR COMPANY, Seoul (KR); Kia Corporation, Seoul (KR)

(21) Appl. No.: 18/388,953

(22) Filed: Nov. 13, 2023

(30) Foreign Application Priority Data
Jun. 20, 2023 (KR) 10-2023-0079186

(51) Int. Cl. B60W 50/02; B60W 10/04; B60W 10/20; B62D 1/28

(52) U.S. Cl. CPC B60W 50/02; B60W 10/04; B60W 10/20; B62D 1/283; B60W 60/00; B60W 2520/16; B60W 2530/201; B60W 2554/402; B60W 2554/802; B60W 2554/804; B60W 2556/10; B60W 2556/35; B60W 2710/20; B60W 2720/106

(57) ABSTRACT

A vehicle control apparatus includes a sensor device including a first sensor and a second sensor, a memory, and a control device. For example, the vehicle control apparatus identifies a first pitch angle of the first sensor and a second pitch angle of the second sensor, expands a sensor fusion range of the sensor device or an error range of each of the first sensor and the second sensor based on the difference if a difference between the first pitch angle and the second pitch angle exceeds a reference value, and performs sensor fusion on detecting results of the first sensor and the second sensor by considering at least one of the sensor fusion range, the error range, or a combination of the sensor fusion range and the error range.

### CROSS-REFERENCE TO RELATED APPLICATION

The present application claims priority to Korean Patent Application No. 10-2023-0079186, filed on Jun. 20, 2023, the entire contents of which is incorporated herein for all purposes by this reference.

### BACKGROUND OF THE PRESENT DISCLOSURE

### Field of the Present Disclosure

The present disclosure relates to a vehicle control apparatus and method thereof, and more particularly, to a technology for generating sensor fusion data by use of a plurality of sensors.

### Description of Related Art

As autonomous driving vehicles are gradually spread, various technologies related to autonomous driving are being developed. The autonomous driving may be divided into partial autonomous driving, conditional autonomous driving, highly autonomous driving, and/or fully autonomous driving depending on a control level.

In the meantime, to perform autonomous driving control for the host vehicle, the vehicle control apparatus may use various types of sensors (e.g., a camera, radio detection and ranging (RADAR), light detection and ranging (RiDAR), or the like) configured to collect information related to surrounding conditions.

As the types of sensors diversify, sensor fusion data may be used to supplement limitations of each sensor. For example, at least part of a plurality of sensors may be classified as one sensor set depending on at least one of a sensor's location, type, detecting range, or any combination thereof, and the sensor fusion data may be generated by use of data obtained by sensors of the classified sensor set.

However, a method according to the related art may consider the mounting location or mounting angle of a sensor when generating the sensor fusion data. However, the method according to the related art does not consider a pitch angle caused by rapid acceleration, rapid deceleration, or impact while a host vehicle is driving. When a change in pitch angle becomes large, a sensor-specific error is greater than an error in a general case, and thus the sensor fusion data may fail to be generated. Because the host vehicle does not properly recognize surrounding objects when the sensor fusion data fails to be generated, the maintenance of an inter-vehicle distance may be imprecisely controlled.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a function of changing a detecting criterion (e.g., a sensor fusion range and/or error range) of a sensor device based on a pitch angle difference between sensors while at least one sensor among a plurality of sensors included in a sensor set that generates sensor fusion data fails to generate the sensor fusion data any more due to the occurrence of a pitch angle.

Various aspects of the present disclosure are directed to providing an exemplary embodiment in which a pitch angle sensor is mounted to identify the pitch angle of each sensor in real time with respect to each location provided with a plurality of sensors for generating sensor fusion data.

Various aspects of the present disclosure are directed to providing a function of storing information obtained by a specific sensor during a specific period before a pitch angle occurs and generating sensor fusion data by selectively using the information, when an area detected by a specific sensor is changed as the pitch angle occurs above a predetermined reference value, and thus sensor fusion data fails to be generated.

Various aspects of the present disclosure are directed to providing a function of storing absolute parameters (e.g., a width, a kind, and a type of another vehicle) that do not change over time from among pieces of information obtained by a specific sensor described above without storing relative parameters (e.g., a relative distance from another vehicle and a relative speed of another vehicle) that change over time, and selectively using the stored information.

Various aspects of the present disclosure are directed to providing a function of maintaining urgent information (e.g., information indicating that another vehicle corresponds to an emergency vehicle) from among pieces of information, which are obtained by use of a specific sensor before a pitch angle occurs, during a specified period even though sensor fusion data fails to be generated, and generating the sensor fusion data by use of the urgent information while data obtained by use of a specific sensor after a pitch angle occurs is not used to generate the sensor fusion data.

Various aspects of the present disclosure are directed to providing a function of performing driving control (e.g., a control including at least one of acceleration, deceleration, steering, or any combination thereof) of a host vehicle by use of the finally generated sensor fusion data.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus includes a sensor device including a first sensor and a second sensor, a memory that stores instructions, and a control device operatively connected to the sensor device and the memory. For example, the instructions executed by the control device, cause the vehicle control apparatus to identify a first pitch angle of the first sensor and a second pitch angle of the second sensor, to expand a sensor fusion range of the sensor device or an error range of each of the first sensor and the second sensor based on the difference when a difference between the first pitch angle and the second pitch angle exceeds a reference value, and to perform sensor fusion on detecting results of the first sensor and the second sensor by considering at least one of the sensor fusion range, the error range, or a combination of the sensor fusion range and the error range.

According to an exemplary embodiment of the present disclosure, the instructions executed by the control device, may cause the vehicle control apparatus to expand the sensor fusion range in proportion to a size of the difference.

According to an exemplary embodiment of the present disclosure, the instructions executed by the control device, may cause the vehicle control apparatus to identify a first existing error range of the first sensor and a second existing error range of the second sensor and to expand the first existing error range and the second existing error range in proportion to a size of the difference when the first existing error range and the second existing error range are identified.

According to an exemplary embodiment of the present disclosure, the instructions executed by the control device, may cause the vehicle control apparatus to determine whether there was another sensor fusion history within a specific period in a past from a point in time when the difference between the first pitch angle and the second pitch angle occurs, when the sensor fusion fails, and to store at least part of information, which is obtained by use of the sensor device at a point in time when the sensor fusion history occurs, in the memory during a predetermined time when the sensor fusion history is present.

According to an exemplary embodiment of the present disclosure, the instructions executed by the control device, may cause the vehicle control apparatus to fail to store first information including at least one of a relative distance between a host vehicle and at least one other vehicle, a relative speed between the host vehicle and the at least one other vehicle, or a combination of the relative distance and the relative speed among the information, and to store second information including at least one of a width of the at least one other vehicle, a type of the at least one other vehicle, a kind of the at least one other vehicle, or a combination of the width, the type, and the kind among the information.

According to an exemplary embodiment of the present disclosure, the instructions executed by the control device, may cause the vehicle control apparatus to replace information related to a track, which is not detected by at least one of the first sensor, the second sensor, or a combination of the first sensor and the second sensor due to the first pitch angle, the second pitch angle, or a combination of the first pitch angle and the second pitch angle, with the second information.

According to an exemplary embodiment of the present disclosure, the instructions executed by the control device, may cause the vehicle control apparatus to classify a type of the at least one other vehicle, of which a vehicle type is not identified in real time due to one of the first pitch angle, the second pitch angle, or a combination of the first pitch angle and the second pitch angle, as the emergency vehicle when it is determined that there is a history in which at least one other vehicle is an emergency vehicle, based on the sensor fusion history.

According to an exemplary embodiment of the present disclosure, the instructions executed by the control device, may cause the vehicle control apparatus to determine whether there was another sensor fusion history within a specific period in a past from a point in time when the difference between the first pitch angle and the second pitch angle occurs when the sensor fusion fails, and to classify information obtained by use of the sensor device as a single track until the sensor fusion is performed, and distinguish and identify the detecting result of the first sensor and the detecting result of the second sensor when the sensor fusion history is not present.

According to an exemplary embodiment of the present disclosure, the sensor device may further include a first pitch angle sensor and a second pitch angle sensor. For example, the instructions executed by the control device, may cause the vehicle control apparatus to identify the first pitch angle of the first sensor by use of the first pitch angle sensor mounted in an area adjacent to the first sensor, and to identify the second pitch angle of the second sensor by use of the second pitch angle sensor existing in an area adjacent to the second sensor.

According to an exemplary embodiment of the present disclosure, the instructions executed by the control device, may cause the vehicle control apparatus to control at least one of acceleration of a host vehicle, deceleration of the host vehicle, steering of the host vehicle, or a combination of the acceleration, the deceleration, and the steering by use of at least part of sensor fusion data generated as a result of performing the sensor fusion.

According to an aspect of the present disclosure, a vehicle control method includes identifying, by a control device, a first pitch angle of the first sensor included in a sensor device and a second pitch angle of the second sensor included in the sensor device, expanding, by the control device, a sensor fusion range of the sensor device or an error range of each of the first sensor and the second sensor based on the difference when a difference between the first pitch angle and the second pitch angle exceeds a reference value, and performing, by the control device, sensor fusion on detecting results of the first sensor and the second sensor by considering at least one of the sensor fusion range, the error range, or a combination of the sensor fusion range and the error range.

According to an exemplary embodiment of the present disclosure, the expanding, by the control device, of the sensor fusion range of the sensor device or the error range of each of the first sensor and the second sensor based on the difference may include expanding, by the control device, the sensor fusion range in proportion to a size of the difference.

According to an exemplary embodiment of the present disclosure, the expanding, by the control device, of the sensor fusion range of the sensor device or the error range of each of the first sensor and the second sensor based on the difference may include identifying, by the control device, a first existing error range of the first sensor and a second existing error range of the second sensor, and expanding, by the control device, the first existing error range and the second existing error range in proportion to a size of the difference when the first existing error range and the second existing error range are identified.

According to an exemplary embodiment of the present disclosure, the vehicle control method may further include determining, by the control device, whether there was another sensor fusion history within a specific period in a past from a point in time when the difference between the first pitch angle and the second pitch angle occurs when the sensor fusion fails, and storing, by the control device, at least part of information, which is obtained by use of the sensor device at a point in time when the sensor fusion history occurs, in a memory during a predetermined time when the sensor fusion history is present.

According to an exemplary embodiment of the present disclosure, the storing, by the control device, of the at least part of information, which is obtained by use of the sensor device at the point in time when the sensor fusion history occurs, in the memory during the predetermined time may include not storing, by the control device, first information including at least one of a relative distance between a host vehicle and at least one other vehicle, a relative speed between the host vehicle and the at least one other vehicle, or a combination of the relative distance and the relative speed among the information, and storing, by the control device, second information including at least one of a width of the at least one other vehicle, a type of the at least one other vehicle, a kind of the at least one other vehicle, or a combination of the width, the type, and the kind among the information.

According to an exemplary embodiment of the present disclosure, the vehicle control method may further include replacing, by the control device, information related to a track, which is not detected by at least one of the first sensor, the second sensor, or a combination of the first sensor and the second sensor due to the first pitch angle, the second pitch angle, or a combination of the first pitch angle and the second pitch angle, with the second information.

According to an exemplary embodiment of the present disclosure, the vehicle control method may further include classifying, by the control device, a type of the at least one other vehicle, of which a vehicle type is not identified in real time due to one of the first pitch angle, the second pitch angle, or a combination of the first pitch angle and the second pitch angle, as the emergency vehicle when it is determined that there is a history in which at least one other vehicle is an emergency vehicle, based on the sensor fusion history.

According to an exemplary embodiment of the present disclosure, the vehicle control method may further include determining, by the control device, whether there was another sensor fusion history within a specific period in a past from a point in time when the difference between the first pitch angle and the second pitch angle occurs when the sensor fusion fails, and classifying, by the control device, information obtained by use of the sensor device as a single track until the sensor fusion is performed, and distinguishing and identifying a detecting result of the first sensor and the detecting result of the second sensor when the sensor fusion history is not present.

According to an exemplary embodiment of the present disclosure, the sensor device may further include a first pitch angle sensor and a second pitch angle sensor. The identifying, by the control device, of the first pitch angle of the first sensor included in the sensor device and the second pitch angle of the second sensor included in the sensor device may include identifying, by the control device, the first pitch angle of the first sensor by use of the first pitch angle sensor mounted in an area adjacent to the first sensor, and identifying, by the control device, the second pitch angle of the second sensor by use of the second pitch angle sensor existing in an area adjacent to the second sensor.

According to an exemplary embodiment of the present disclosure, the vehicle control method may further include controlling, by the control device, at least one of acceleration of a host vehicle, deceleration of the host vehicle, steering of the host vehicle, or a combination of the acceleration, the deceleration, and the steering by use of at least part of sensor fusion data generated as a result of performing the sensor fusion.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing components of a vehicle control apparatus, according to an exemplary embodiment of the present disclosure;

FIG. 2 is a block diagram showing components of a vehicle control apparatus, according to an exemplary embodiment of the present disclosure;

FIG. 3 is a conceptual diagram illustrating an operation of a vehicle control apparatus, according to an exemplary embodiment of the present disclosure;

FIG. 4 is a flowchart of an operation of a vehicle control apparatus, according to an exemplary embodiment of the present disclosure;

FIG. 5 is a flowchart of an operation of a vehicle control apparatus, according to an exemplary embodiment of the present disclosure; and

FIG. 6 illustrates a computing system related to a vehicle control method, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to components of each drawing, it should be noted that the same components include the same reference numerals, although they are indicated on another drawing. Furthermore, in describing the exemplary embodiments of the present disclosure, detailed descriptions associated with well-known functions or configurations will be omitted when they may make subject matters of the present disclosure unnecessarily obscure.

In describing elements of an exemplary embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning which is consistent with their meaning in the context of the present disclosure and the relevant art and will not be interpreted in an idealized or overly formal sense unless so defined herein.

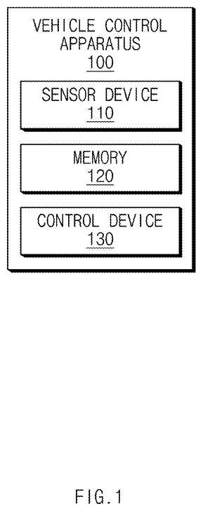

Hereinafter, various embodiments of the present disclosure will be described in detail with reference to FIGS. 1 to 6.

FIG. 1 is a block diagram showing components of a vehicle control apparatus, according to an exemplary embodiment of the present disclosure.

According to an exemplary embodiment of the present disclosure, a vehicle control apparatus 100 may include at least one of a sensor device 110, a memory 120, a control device 130, or any combination thereof. The configuration of the vehicle control apparatus 100 shown in FIG. 1 is an example, and embodiments of the present disclosure are not limited thereto. For example, the vehicle control apparatus 100 may further include components (e.g., at least one of an interface device, a communication device, a display device, a driver, or any combination thereof) not shown in FIG. 1.

According to an exemplary embodiment of the present disclosure, the sensor device 110 may obtain (or sense) various pieces of information used for the driving of a vehicle.

For example, the sensor device 110 may include a first sensor and a second sensor. For example, the first sensor may include a camera, and the second sensor may include radar and/or LiDAR.

For example, the sensor device 110 may include at least one sensor including at least one of a camera, radar, LiDAR, or any combination thereof. For example, the sensor device 110 may further include at least one pitch angle sensor mounted in an area adjacent to a location at which the at least one sensor is mounted. For example, the sensor device 110 may identify a first pitch angle of the first sensor by use of a first pitch angle sensor mounted in an area adjacent to the first sensor, and may identify a second pitch angle of the second sensor by use of a second pitch angle sensor mounted in an area adjacent to the second sensor.

For example, the pitch angle sensor may include at least one of a gyro sensor, a proximity sensor, a direction detection sensor, or any combination thereof, but this is an example and embodiments of the present disclosure are not limited thereto. The sensor device 110 may identify a pitch angle of at least one sensor corresponding to the corresponding pitch angle sensor through at least part of information obtained by the pitch angle sensor.

For example, the sensor device 110 may obtain various pieces of information to perform driving control (e.g., autonomous driving control) on the host vehicle.

For example, the sensor device 110 may obtain information related to an external object (e.g., at least one of a person, another vehicle, a building, a structure, or any combination thereof) by use of at least one sensor.

For example, the sensor device 110 may obtain information related to whether at least one other vehicle is present and/or a driving state (e.g., at least one of a driving speed, a driving direction, a separation distance from a host vehicle, whether a vehicle is stopped, or any combination thereof).

According to an exemplary embodiment of the present disclosure, the memory 120 may store instructions or data. For example, the memory 120 may store one or more instructions that cause the vehicle control apparatus 100 to perform various operations when executed by the control device 130.

For example, the memory 120 and the control device 130 may be implemented as one chipset. The control device 130 may include at least one of a communication processor or a modem.

According to an exemplary embodiment of the present disclosure, the control device 130 may be operatively connected to the sensor device 110 and/or the memory 120. For example, the control device 130 may be configured for controlling the operation of the sensor device 110 and/or the memory 120.

For example, the control device 130 may identify a first pitch angle of the first sensor (e.g., a camera) included in the sensor device 110 and a second pitch angle of the second sensor (e.g., radar) included in the sensor device 110.

For example, the first sensor and the second sensor may be sensors including overlapping detecting areas. The control device 130 may be configured to generate sensor fusion data by use of detecting data obtained by the first sensor and detecting data obtained by the second sensor.

For example, the control device 130 may identify the first pitch angle of the first sensor by use of a first pitch angle sensor mounted (or placed) in an area adjacent to the first sensor.

For example, the control device 130 may identify the second pitch angle of the second sensor by use of a second pitch angle sensor mounted (or placed) in an area adjacent to the second sensor.

For example, the control device 130 may be configured to determine whether a difference between the first pitch angle and the second pitch angle exceeds a reference value. For example, the reference value may be changeable by a user or may be a setting value set by a manufacturer.

For example, when the difference between the first pitch angle and the second pitch angle exceeds the reference value, the control device 130 may expand a sensor fusion range of the sensor device 110 or an error range of the sensor device based on the identified difference.

For example, based on the identified difference, the control device 130 may expand the sensor fusion range of the sensor device 110 which is based on the first sensor and the second sensor. The sensor fusion range may be a detecting range used when sensor fusion data is generated by use of the first sensor and the second sensor. For example, the control device 130 may expand the sensor fusion range in proportion to the size of the difference. In other words, the control device 130 may greatly expand the sensor fusion range as the difference between the first pitch angle and the second pitch angle increases.

For example, the control device 130 may expand the error range of each of the first sensor and the second sensor included in the sensor device 110 based on the identified difference. The error range may be set for each of the first sensor and the second sensor, and may be a margin range used when each sensor obtains detecting data. For example, the control device 130 may identify a first existing error range of the first sensor and a second existing error range of the second sensor and then may expand an existing error range of each sensor in proportion to the size of the difference. In other words, the control device 130 may greatly expand the error range as the difference between the first pitch angle and the second pitch angle increases.

For example, the control device 130 may perform sensor fusion through data, which is obtained by use of sensors included in the sensor device 110, by considering at least one of the expanded sensor fusion range, the expanded error range, or any combination thereof.

For example, the control device 130 may be configured for controlling driving of the host vehicle by use of at least part of sensor fusion data obtained by performing sensor fusion.

For example, the control device 130 may be configured for controlling at least one of acceleration of the host vehicle, deceleration of the host vehicle, steering of the host vehicle, or any combination thereof by use of at least part of sensor fusion data generated as a result of performing sensor fusion.

For example, when sensor fusion fails, the control device 130 may be configured to determine whether there was another sensor fusion history within a specific period in the past from a point in time when a difference between the first pitch angle and the second pitch angle occurs.

For example, when there was another sensor fusion history within a specific period in the past from the point in time when the difference occurs, the control device 130 may store at least part of information obtained by use of the sensor device 110 in the memory 120 during a specified time at a point in time when sensor fusion history occurs.

For example, the control device 130 may identify a specific sensor, which is not used to generate sensor fusion data as a difference between pitch angles occurs, from among a plurality of sensors used to generate the sensor fusion data at a point in time (or a point in time when sensor fusion was performed in the past and which is identified based on a sensor fusion history) when a sensor fusion history occurs, and may store, in the memory 120, at least part of information obtained by the identified specific sensor during a specified time at a point in time when sensor fusion was performed in the past.

For example, among pieces of information obtained by the specific sensor at a point in time when sensor fusion was performed in the past, the control device 130 may not store, in the memory 120, first information including at least one of a relative distance between the host vehicle and at least one other vehicle, a relative speed between the host vehicle and at least one other vehicle, or any combination thereof.

For example, among pieces of information obtained by the specific sensor at a point in time when sensor fusion was performed in the past, the control device 130 may store, in the memory 120, second information including at least one of a width of at least one other vehicle, a kind of at least one other vehicle, a type of at least one other vehicle, or any combination thereof.

In other words, the control device 130 may store absolute parameters (e.g., a width, a kind, and a type of another vehicle) that do not change over time from among pieces of information obtained by a specific sensor without storing relative parameters (e.g., a relative distance from another vehicle and a relative speed of another vehicle) that change over time.

For example, the control device 130 may replace information related to a track, which is not detected by at least one of the first sensor, the second sensor, or any combination thereof due to the first pitch angle, the second pitch angle, or any combination thereof, with the second information.

For example, a track may include information indicating a location where an object has passed. The control device 130 may identify the speed or moving direction of an object by use of the track.

For example, the control device 130 may identify a specific sensor, which is not used to generate sensor fusion data due to the occurrence of a pitch angle in the first sensor and the second sensor, may replace information related to a track, which is not detected by the specific sensor, with the second information stored in the memory 120, and may use the second information as the sensor fusion data for vehicle driving control.

For example, when the generation of sensor fusion data has failed due to the occurrence of a pitch angle, the control device 130 may fuse information related to the width and/or type of another vehicle, which is obtained by use of the first sensor at a point in time when sensor fusion was performed in the past, with information obtained by the second sensor.

For example, when there is a history of identifying urgent information (e.g., information indicating that another vehicle corresponds to an emergency vehicle) among pieces of information obtained by use of the first sensor at a point in time when sensor fusion was performed in the past, the control device 130 may fuse the urgent information with information obtained by the second sensor even though the second sensor does not identify the type of the other vehicle. In other words, even though the second sensor does not currently identify the type of another vehicle, the type of the other vehicle may be classified as an emergency vehicle with reference to a past sensor fusion history.

For example, when there was no other sensor fusion history within a specific period in the past from a point in time when a difference occurred, the control device 130 may classify, as a single track, information obtained by use of the sensor device 110 from a specific time point in the past (e.g., a time point before a specific period from the current time point) until the failed time point (or a point in time when sensor fusion was performed) after current sensor fusion is performed, and may distinguish and identify the detecting result of the first sensor and the detecting result of the second sensor. In other words, with respect to the first and second sensors, which did not generate sensor fusion data in the past and which fails to perform sensor fusion even after correcting (or expanding) a sensor fusion range and/or error range based on a pitch angle difference, the control device 130 may distinguish and identify pieces of information obtained by each of the sensors and may classify the identified result as a single track.

For example, the control device 130 may perform driving control on at least one of acceleration of the host vehicle, deceleration of the host vehicle, steering of the host vehicle, or any combination thereof by use of at least part of sensor fusion data generated as a result of finally performing sensor fusion.

For example, when the sensor fusion fails, the control device 130 may be configured to generate sensor fusion data by use of at least part of the stored information (e.g., second information) based on past sensor fusion history, and may perform driving control of the host vehicle by use of at least part of the generated sensor fusion data.

For example, when sensor fusion fails and there is no past sensor fusion history, the control device 130 may be configured to process each sensor as a single track and may perform driving control of the host vehicle by use of information obtained by each sensor.

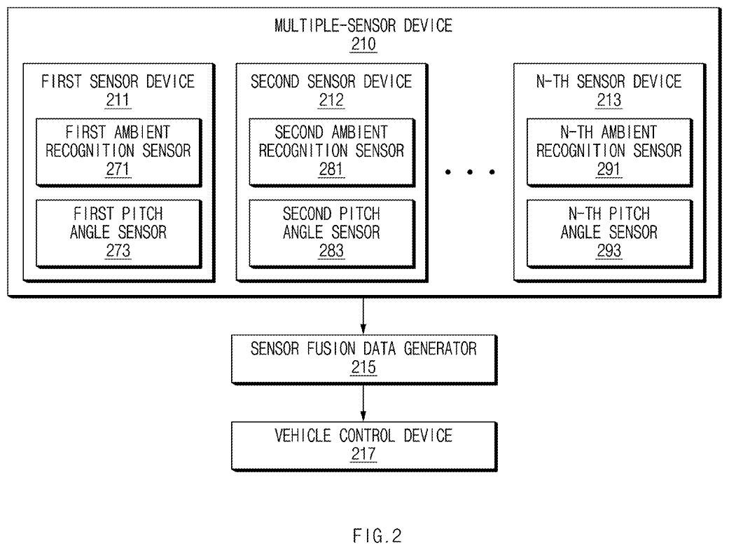

FIG. 2 is a block diagram showing components of a vehicle control apparatus, according to an exemplary embodiment of the present disclosure.

According to an exemplary embodiment of the present disclosure, a vehicle control apparatus (e.g., the vehicle control apparatus 100 of FIG. 1) may include a multiple-sensor device 210, a sensor fusion data generator 215, and a vehicle control device 217. For example, the multiple-sensor device 210 may include a first sensor device 211, a second sensor device 212, . . . , an n-th sensor device 213. For example, the first sensor device 211 may include a first ambient recognition sensor 271 and a first pitch angle sensor 273; the second sensor device 212 may include a second ambient recognition sensor 281 and a second pitch angle sensor 283; and the n-th sensor device 213 may include an n-th ambient recognition sensor 291 and an n-th pitch angle sensor 293.

For example, the multiple-sensor device 210 may be implemented as a part of the sensor device 110 of FIG. 1 described above.

For example, as sensor devices included in the multiple-sensor device 210, the first sensor device 211 to the n-th sensor device 213 may include at least one sensor having various types.

For example, each of the ambient recognition sensors 271, 281, and 291 may include at least one of a camera, radar, LIDAR, or any combination thereof. The ambient recognition sensors 271, 281, and 291 may obtained various pieces of information (e.g., information related to an external object, environment information, or the like) about a specific area around a host vehicle.

For example, the pitch angle sensors 273, 283, and 293 may be mounted in areas adjacent to the ambient recognition sensors 271, 281, and 291 and may be configured to identify pitch angles of the ambient recognition sensors 271, 281, and 291, respectively. For example, each of the pitch angle sensors 273, 283, and 293 may include at least one of a gyro sensor, a proximity sensor, a direction detection sensor, or any combination thereof, but this is an example and embodiments of the present disclosure are not limited thereto.

For example, FIG. 2 shows that the sensor devices respectively include pitch angle sensors 273, 283, and 293. However, various exemplary embodiments of the present disclosure are not limited thereto. For example, when pitch angles are substantially the same as each other because the first ambient recognition sensor 271 and the second ambient recognition sensor 281 are adjacent to each other, the first sensor device 211 and the second sensor device 212 may share one pitch angle sensor with each other. In other words, the first sensor device 211 and the second sensor device 212 may operate to share one pitch angle sensor (e.g., the first pitch angle sensor 273) without, respectively including the pitch angle sensors 273 and 283.

For example, the sensor fusion data generator 215 may perform sensor fusion on at least part of information obtained from the multiple-sensor device 210.

For example, the sensor fusion data generator 215 may identify at least one sensor set based on a detecting range, a detecting type, an error range, and a sensor fusion range of each of sensor devices, and may be configured to generate sensor fusion data based on each sensor set.

For example, the sensor fusion data generator 215 may identify a pitch angle of each sensor included in a sensor set. When a difference between pitch angles is greater than or equal to a predetermined reference value, the sensor fusion data generator 215 may correct (or enlarge) a sensor fusion range and/or an error range of each sensor based on the size of the difference, and then may be configured to generate sensor fusion data based on the corresponding sensor set.

For example, the vehicle control device 217 may perform driving control on at least one of acceleration of the host vehicle, deceleration of the host vehicle, steering of the host vehicle, or any combination thereof by use of at least part of sensor fusion data generated as a result of performing sensor fusion received from the sensor fusion data generator 215.

Components of the vehicle control apparatus illustrated in FIG. 2 are examples, and embodiments of the present disclosure are not limited thereto. For example, FIG. 2 illustrates that the sensor fusion data generator 215 and the vehicle control device 217 are distinct components, but may be implemented as a single chip (or a component (e.g., the control device 130 of FIG. 1)).

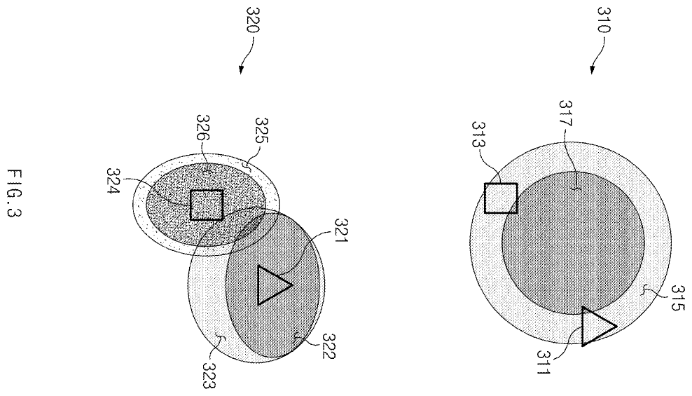

FIG. 3 is a conceptual diagram illustrating an operation of a vehicle control apparatus, according to an exemplary embodiment of the present disclosure.

Referring to reference number 310, according to an exemplary embodiment of the present disclosure, a vehicle control apparatus (e.g., the vehicle control apparatus 100 of FIG. 1) may expand a sensor fusion range based on a difference in a pitch angle between sensors.

For example, the vehicle control apparatus may identify a first detecting target 311 of a first sensor and a second detecting target 313 of a second sensor. For example, the first sensor and the second sensor may be components of a sensor set used to generate sensor fusion data before the pitch angle difference exceeds a reference value.

For example, before the pitch angle difference exceeds the reference value, the vehicle control apparatus may perform sensor fusion on pieces of information, which are obtained by the first sensor and the second sensor, based on a first sensor fusion range 317.

For example, when the pitch angle difference exceeds the reference value, the vehicle control apparatus may identify that detecting fusion data regarding pieces of information related to the first detecting target 311 and the second detecting target 313 may not be generated, based on the first sensor fusion range 317. Accordingly, when the pitch angle difference exceeds the reference value, the vehicle control apparatus may expand the first sensor fusion range 317 to a second sensor fusion range 315 in proportion to the size of the pitch angle difference and may perform sensor fusion on pieces of information obtained by the first sensor and the second sensor based on the expanded second sensor fusion range 315.

In the present way, when the pitch angle difference exceeds the reference value and thus the first sensor or the second sensor is not available to generate sensor fusion data, the vehicle control apparatus may be configured to generate sensor fusion data including the first detecting target 311 and the second detecting target 313 by expanding the first sensor fusion range 317 to the second sensor fusion range 315.

Referring to reference number 320, according to an exemplary embodiment of the present disclosure, the vehicle control apparatus may expand the error range of each of sensors included in the sensor set based on the pitch angle difference between the sensors.

For example, the vehicle control apparatus may identify a third detecting target 321 of the first sensor and a fourth detecting target 324 of the second sensor. For example, the first sensor and the second sensor may be components of a sensor set used to generate sensor fusion data before the pitch angle difference exceeds a reference value.

For example, before the pitch angle difference exceeds the reference value, the vehicle control apparatus may perform sensor fusion on pieces of information, which are obtained by the first sensor and the second sensor, based on a first error range 322 of the first sensor and a second error range 326 of the second sensor.

For example, when the pitch angle difference exceeds the reference value, the vehicle control apparatus may identify that detecting fusion data regarding pieces of information related to the third detecting target 321 and the fourth detecting target 324 may no longer be generated, based on the first error range 322 and the second error range 326. Accordingly, when the pitch angle difference exceeds the reference value, the vehicle control apparatus may expand the first error range 322 to a third error range 323 in proportion to the size of the pitch angle difference and may expand the second error range 326 to a fourth error range 325. For example, the vehicle control apparatus may perform sensor fusion on pieces of information, which are obtained by the first sensor and the second sensor, based on the enlarged third error range 323 and the enlarged fourth error range 325.

In the present way, in situations where the pitch angle difference exceeds the reference value and thus the first or second sensor is no longer available to generate sensor fusion data, the vehicle control apparatus may be configured to generate sensor fusion data including the third detecting target 321 and the fourth detecting target 324 by respectively expanding the first error range 322 and the second error range 326 to the third error range 323 and the fourth error range 325.

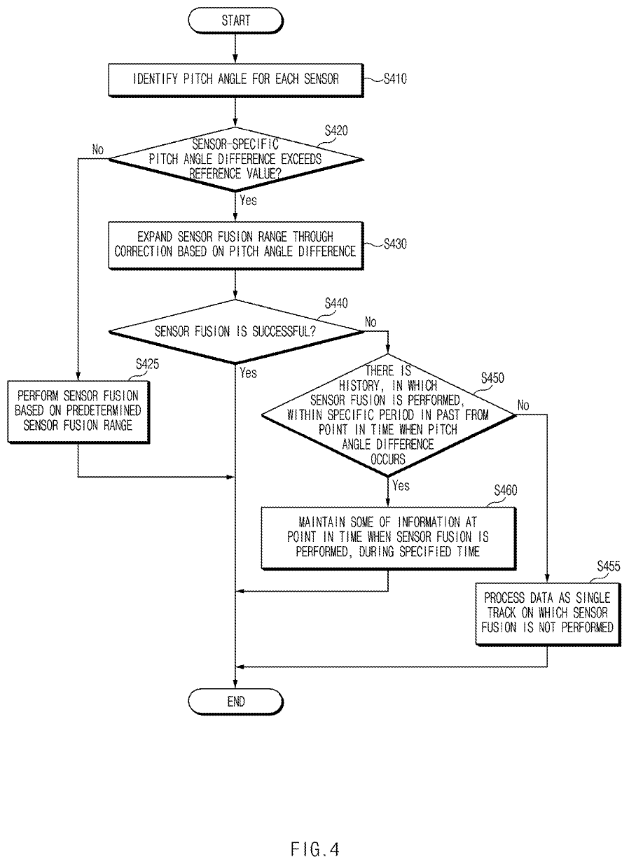

FIG. 4 is a flowchart of an operation of a vehicle control apparatus, according to an exemplary embodiment of the present disclosure.

According to an exemplary embodiment of the present disclosure, a vehicle control apparatus (e.g., the vehicle control apparatus 100 of FIG. 1) may perform operations described in FIG. 4. For example, at least some of components (e.g., the sensor device 110, the memory 120, and the controller 130 in FIG. 1) included in the vehicle control apparatus may be set to perform operations of FIG. 4.

In the following embodiment, operation S410 to operation S460 may be sequentially performed, but are not always performed sequentially. For example, the order of operations may be changed, and at least two operations may be performed in parallel. Moreover, descriptions corresponding to or identical to the above-mentioned descriptions provided with reference to FIG. 4 may be briefly described or omitted to avoid redundancy.

According to an exemplary embodiment of the present disclosure, the vehicle control apparatus may identify a pitch angle for each sensor (S410).

For example, the vehicle control apparatus may monitor the sensor-specific pitch angle in real time by use of at least one pitch angle sensor (e.g., a gyro sensor) mounted in an area adjacent to each of sensors mounted on a host vehicle.

According to an exemplary embodiment of the present disclosure, the vehicle control apparatus may be configured to determine whether the sensor-specific pitch angle difference exceeds a reference value (S420).

For example, the vehicle control apparatus may identify a pitch angle of each of sensors included in a sensor set that previously generates sensor fusion data and may identify whether a difference in pitch angle of each of the sensors exceeds the predetermined reference value.

For example, when the sensor-specific pitch angle difference exceeds the reference value (e.g., operation S420—Yes), the vehicle control apparatus may perform operation S430.

For example, when the sensor-specific pitch angle difference is less than or equal to the reference value (e.g., operation S420—No), the vehicle control apparatus may perform operation S425.

According to an exemplary embodiment of the present disclosure, the vehicle control apparatus may perform sensor fusion based on a predetermined sensor fusion range (S425).

For example, when the pitch angle difference is less than or equal to the reference value, the vehicle control apparatus may be configured to determine to generate sensor fusion data even with the existing sensor fusion data generation criterion and may perform the sensor fusion based on a predetermined criterion (e.g., a sensor fusion range and/or an error range).

According to an exemplary embodiment of the present disclosure, the vehicle control apparatus may expand the sensor fusion range through correction based on the pitch angle difference (S430).

For example, the vehicle control apparatus may expand the sensor fusion range in proportion to the pitch angle difference.

For example, additionally or alternatively, the vehicle control apparatus may expand the error range of each of sensors included in the sensor set in proportion to the pitch angle difference.

According to an exemplary embodiment of the present disclosure, the vehicle control apparatus may be configured to determine whether the sensor fusion is successful (S440).

For example, the vehicle control apparatus may be configured to determine whether the sensor fusion using pieces of detecting information, which are obtained through the sensor set based on the sensor fusion criterion corrected in operation S430, is successful.

For example, when the sensor fusion is successful (e.g., operation S440—Yes), the vehicle control apparatus may end the procedure. For example, when the sensor fusion successful, the vehicle control apparatus may perform driving control on the host vehicle by use of the generated sensor fusion data.

For example, when the sensor fusion is not successful (e.g., operation S440—No), the vehicle control apparatus may perform operation S450.

According to an exemplary embodiment of the present disclosure, the vehicle control apparatus may be configured to determine whether there is a history, in which the sensor fusion is performed, within a specific period in the past from a point in time when the pitch angle difference occurs (S450).

For example, when the history, in which the sensor fusion is performed, within the specific period in the past from the point in time when the pitch angle difference occurs is present (e.g., operation S450—Yes), the vehicle control apparatus may perform operation S460.

For example, when there is no history, in which the sensor fusion is performed, within the specific period in the past from the point in time when the pitch angle difference occurs (e.g., operation S450—No), the vehicle control apparatus may perform operation S455.

According to an exemplary embodiment of the present disclosure, the vehicle control apparatus may be configured to process pieces of data obtained through sensors included in the sensor set as a single track on which sensor fusion is not performed (S455).

For example, the vehicle control apparatus may classify information obtained by use of the sensor set until the sensor fusion is performed as a single track and may distinguish and identify the detecting result of each sensor included in the sensor set.

According to an exemplary embodiment of the present disclosure, the vehicle control apparatus may maintain some of information at a point in time when the sensor fusion is performed, during a specified time (S460).

For example, at a point in time (or a point in time when sensor fusion was performed in the past and which is identified based on a sensor fusion history) when a sensor fusion history occurs, the vehicle control apparatus may store, in a memory, at least part of information, which is obtained by a specific sensor and which is identified as not being used for sensor fusion data any longer because an excessive pitch angle occurs, from among sensors included in the sensor set during a specified time.

For example, the vehicle control apparatus may not store first information, which includes at least one of a relative distance between the host vehicle and at least one other vehicle, a relative speed between the host vehicle and the at least one other vehicle, or any combination thereof, from among information obtained by the specific sensor.

For example, the vehicle control apparatus may store second information, which includes at least one of a width of at least one other vehicle, a kind of the at least one other vehicle, a type of the at least one other vehicle, or any combination thereof, from among information obtained by the specific sensor.

For example, the vehicle control apparatus may be configured to generate sensor fusion data by use of the second information and information, which is obtained by other sensors other than the specific sensor, from among the information obtained by the specific sensor.

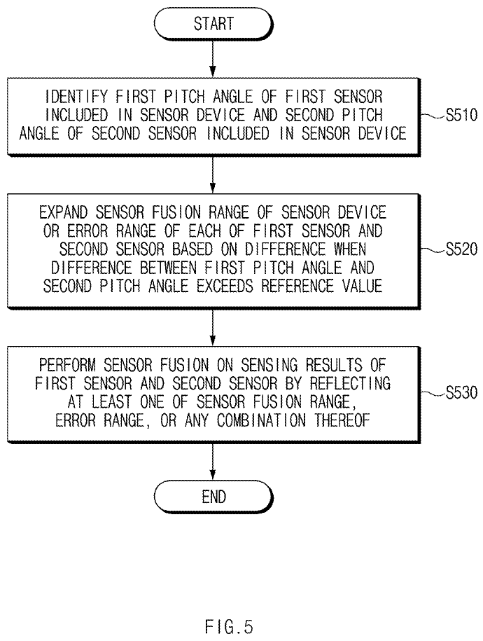

FIG. 5 is a flowchart of an operation of a vehicle control apparatus, according to an exemplary embodiment of the present disclosure.

According to an exemplary embodiment of the present disclosure, a vehicle control apparatus (e.g., the vehicle control apparatus 100 of FIG. 1) may perform operations described in FIG. 5. For example, at least some of components (e.g., the sensor device 110, the memory 120, and the controller 130 in FIG. 1) included in the vehicle control apparatus may be set to perform operations of FIG. 5.

In the following embodiment, operation S510 to operation S530 may be sequentially performed, but are not always performed sequentially. For example, the order of operations may be changed, and at least two operations may be performed in parallel. Moreover, descriptions corresponding to or identical to the above-mentioned descriptions provided with reference to FIG. 5 may be briefly described or omitted to avoid redundancy.

According to an exemplary embodiment of the present disclosure, the vehicle control apparatus may identify a first pitch angle of a first sensor included in a sensor device and a second pitch angle of a second sensor included in a sensor device (S510).

For example, the vehicle control apparatus may identify the first pitch angle of the first sensor by use of a first pitch angle sensor mounted in an area adjacent to the first sensor, and may identify the second pitch angle of the second sensor by use of a second pitch angle sensor which is present in an area adjacent to the second sensor.

According to an exemplary embodiment of the present disclosure, when a difference between the first pitch angle and the second pitch angle exceeds a reference value, the vehicle control apparatus may expand a sensor fusion range of the sensor device or an error range of each of the first sensor and the second sensor based on the identified difference (S520).

For example, the vehicle control apparatus may expand the sensor fusion range for generating sensor fusion data in proportion to a size of the difference.

For example, the vehicle control apparatus may identify a first existing error range of the first sensor and a second existing error range of the second sensor. When the first existing error range and the second existing error range are identified, the vehicle control apparatus may expand the first existing error range and the second existing error range in proportion to the size of the difference.

An exemplary embodiment of expanding a sensor fusion range and an error range may be described with reference to FIG. 3.

According to an exemplary embodiment of the present disclosure, the vehicle control apparatus may perform sensor fusion on detecting results of the first sensor and the second sensor by considering at least one of a sensor fusion range, an error range, or any combination thereof (S530).

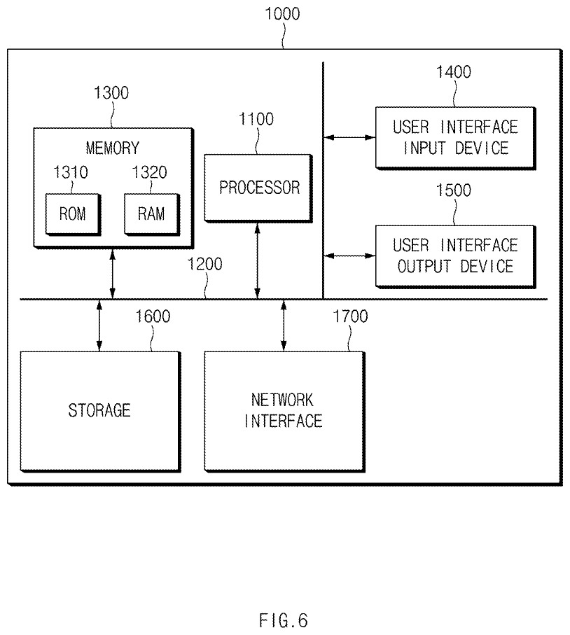

FIG. 6 illustrates a computing system related to a vehicle control method, according to an exemplary embodiment of the present disclosure.

Referring to FIG. 8, a computing system 1000 related to a vehicle control method may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the exemplary embodiments included in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, various exemplary embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of a vehicle control apparatus according to an exemplary embodiment of the present disclosure, and a method thereof are as follows.

According to at least one of embodiments of the present disclosure, when sensor fusion data fails to be generated as a pitch angle of a specific sensor increases to be greater than or equal to a reference value due to situations such as rapid acceleration, rapid deceleration, and impact to the vehicle body while the host vehicle is driving, a vehicle control apparatus may expand a detecting range (e.g., a sensor fusion range and/or error range) of a sensor device to continuously generate sensor fusion data based on the size of a pitch angle difference between sensors that previously generated the sensor fusion data.

Moreover, according to at least one of embodiments of the present disclosure, before a pitch angle occurs to be greater than or equal to the reference value, the vehicle control apparatus may store data obtained by a specific sensor and may be configured to generate the sensor fusion data by use of some of the stored data, providing a user with a stable host vehicle control function.

Furthermore, according to at least one of embodiments of the present disclosure, when the pitch angle is greater than the reference value, the maintenance of an inter-vehicle distance may be stably and accurately controlled by improving the detection accuracy of external elements (e.g., other vehicles) adjacent to the host vehicle.

Besides, a variety of effects directly or indirectly understood through the present disclosure may be provided.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle control apparatus comprising:
a sensor device including a first sensor and a second sensor;
a memory configured to store instructions; and
a control device operatively connected to the sensor device and the memory,
wherein the instructions executed by the control device, cause the vehicle control apparatus to:
identify a first pitch angle of the first sensor and a second pitch angle of the second sensor;
in response that a difference between the first pitch angle and the second pitch angle exceeds a reference value, expand a sensor fusion range of the sensor device or an error range of each of the first sensor and the second sensor based on the difference; and
perform sensor fusion on detecting results of the first sensor and the second sensor by considering at least one of the sensor fusion range, the error range, or a combination of the sensor fusion range and the error range.

2. The vehicle control apparatus of claim 1, wherein the instructions executed by the control device, cause the vehicle control apparatus to:
expand the sensor fusion range in proportion to a size of the difference.

3. The vehicle control apparatus of claim 1, wherein the instructions executed by the control device, cause the vehicle control apparatus to:
identify a first existing error range of the first sensor and a second existing error range of the second sensor; and
in response that the first existing error range and the second existing error range are identified, expand the first existing error range and the second existing error range in proportion to a size of the difference.

4. The vehicle control apparatus of claim 1, wherein the instructions executed by the control device, cause the vehicle control apparatus to:
in response that the sensor fusion fails, determine whether there was another sensor fusion history within a predetermined period in a past from a point in time in response that the difference between the first pitch angle and the second pitch angle occurs; and
in response that the sensor fusion history is present, store at least part of information, which is obtained by use of the sensor device at a point in time in response that the sensor fusion history occurs, in the memory during a predetermined time.

5. The vehicle control apparatus of claim 4, wherein the instructions executed by the control device, cause the vehicle control apparatus to:
fail to store first information including at least one of a relative distance between a host vehicle and at least one other vehicle, a relative speed between the host vehicle and the at least one other vehicle, or a combination of the relative distance and the relative speed among the information; and
store second information including at least one of a width of the at least one other vehicle, a type of the at least one other vehicle, a kind of the at least one other vehicle, or a combination of the width, the type, and the kind among the information.

6. The vehicle control apparatus of claim 5, wherein the instructions executed by the control device, cause the vehicle control apparatus to:
replace information related to a track, which is not detected by at least one of the first sensor, the second sensor, or a combination of the first sensor and the second sensor due to the first pitch angle, the second pitch angle, or a combination of the first pitch angle and the second pitch angle, with the second information.

7. The vehicle control apparatus of claim 4, wherein the instructions executed by the control device, cause the vehicle control apparatus to:
in response that the control device concludes that there is a history in which at least one other vehicle is an emergency vehicle, based on the sensor fusion history, classify a type of the at least one other vehicle, of which a vehicle type is not identified in real time due to one of the first pitch angle, the second pitch angle, or a combination of the first pitch angle and the second pitch angle, as the emergency vehicle.

8. The vehicle control apparatus of claim 1, wherein the instructions executed by the control device, cause the vehicle control apparatus to:
in response that the sensor fusion fails, determine whether there was another sensor fusion history within a predetermined period in a past from a point in time in response that the difference between the first pitch angle and the second pitch angle occurs; and
in response that the sensor fusion history is not present, classify information obtained by use of the sensor device as a single track until the sensor fusion is performed, and distinguish and identify the detecting result of the first sensor and the detecting result of the second sensor.

9. The vehicle control apparatus of claim 1, wherein the sensor device further includes a first pitch angle sensor and a second pitch angle sensor, and
wherein the instructions executed by the control device, cause the vehicle control apparatus to:
identify the first pitch angle of the first sensor by use of the first pitch angle sensor mounted in an area adjacent to the first sensor; and
identify the second pitch angle of the second sensor by use of the second pitch angle sensor existing in an area adjacent to the second sensor.

10. The vehicle control apparatus of claim 1, wherein the instructions executed by the control device, cause the vehicle control apparatus to:
control at least one of acceleration of a host vehicle, deceleration of the host vehicle, steering of the host vehicle, or a combination of the acceleration, the deceleration, and the steering by use of at least part of sensor fusion data generated as a result of performing the sensor fusion.

11. A vehicle control method, the method comprising:
identifying, by a control device, a first pitch angle of a first sensor included in a sensor device and a second pitch angle of a second sensor included in the sensor device;
in response that a difference between the first pitch angle and the second pitch angle exceeds a reference value, expanding, by the control device, a sensor fusion range of the sensor device or an error range of each of the first sensor and the second sensor based on the difference; and
performing, by the control device, sensor fusion on detecting results of the first sensor and the second sensor by considering at least one of the sensor fusion range, the error range, or a combination of the sensor fusion range and the error range.

12. The method of claim 11, wherein the expanding, by the control device, of the sensor fusion range of the sensor device or the error range of each of the first sensor and the second sensor based on the difference includes:
expanding, by the control device, the sensor fusion range in proportion to a size of the difference.

13. The method of claim 11, wherein the expanding, by the control device, of the sensor fusion range of the sensor device or the error range of each of the first sensor and the second sensor based on the difference includes:
identifying, by the control device, a first existing error range of the first sensor and a second existing error range of the second sensor; and
in response that the first existing error range and the second existing error range are identified, expanding, by the control device, the first existing error range and the second existing error range in proportion to a size of the difference.

14. The method of claim 11, further including:
in response that the sensor fusion fails, determining, by the control device, whether there was another sensor fusion history within a predetermined period in a past from a point in time in response that the difference between the first pitch angle and the second pitch angle occurs; and
in response that the sensor fusion history is present, storing, by the control device, at least part of information, which is obtained by use of the sensor device at a point in time in response that the sensor fusion history occurs, in a memory during a predetermined time.

15. The method of claim 14, wherein the storing, by the control device, of the at least part of information, which is obtained by use of the sensor device at the point in time in response that the sensor fusion history occurs, in the memory during the predetermined time includes:
not storing, by the control device, first information including at least one of a relative distance between a host vehicle and at least one other vehicle, a relative speed between the host vehicle and the at least one other vehicle, or a combination of the relative distance and the relative speed among the information; and
storing, by the control device, second information including at least one of a width of the at least one other vehicle, a type of the at least one other vehicle, a kind of the at least one other vehicle, or a combination of the width, the type, and the kind among the information.

16. The method of claim 15, further including:
replacing, by the control device, information related to a track, which is not detected by at least one of the first sensor, the second sensor, or a combination of the first sensor and the second sensor due to the first pitch angle, the second pitch angle, or a combination of the first pitch angle and the second pitch angle, with the second information.

17. The method of claim 14, further including:
in response that the control device concludes that there is a history in which at least one other vehicle is an emergency vehicle, based on the sensor fusion history, classifying, by the control device, a type of the at least one other vehicle, of which a vehicle type is not identified in real time due to one of the first pitch angle, the second pitch angle, or a combination of the first pitch angle and the second pitch angle, as the emergency vehicle.

18. The method of claim 11, further including:
in response that the sensor fusion fails, determining, by the control device, whether there was another sensor fusion history within a predetermined period in a past from a point in time in response that the difference between the first pitch angle and the second pitch angle occurs; and
in response that the sensor fusion history is not present, classifying, by the control device, information obtained by use of the sensor device as a single track until the sensor fusion is performed, and distinguishing and identifying the detecting result of the first sensor and the detecting result of the second sensor.

19. The method of claim 11, wherein the sensor device further includes a first pitch angle sensor and a second pitch angle sensor, and
wherein the identifying, by the control device, of the first pitch angle of the first sensor included in the sensor device and the second pitch angle of the second sensor included in the sensor device includes:
identifying, by the control device, the first pitch angle of the first sensor by use of the first pitch angle sensor mounted in an area adjacent to the first sensor; and
identifying, by the control device, the second pitch angle of the second sensor by use of the second pitch angle sensor existing in an area adjacent to the second sensor.

20. The method of claim 11, further including:
controlling, by the control device, at least one of acceleration of a host vehicle, deceleration of the host vehicle, steering of the host vehicle, or a combination of the acceleration, the deceleration, and the steering by use of at least part of sensor fusion data generated as a result of performing the sensor fusion.
